(19) United States
(12) Patent Application Publication
(10) Pub. No.: US 2026/0037852 A1
(43) Pub. Date: Feb. 5, 2026

(54) QUANTUM CIRCUIT COMPILATION INDEPENDENT OF CALIBRATION

(71) Applicant: International Business Machines Corporation, Armonk, NY (US)

(72) Inventors: Thomas Alexander, Halifax (CA); Marius Hillenbrand, Boeblingen (DE); Andrew Wack, Millbrook, NY (US); Johannes Severin Kern, Boeblingen (DE); Utz Bacher, Dettenhausen (DE); Thilo Maurer, Nufringen (DE); Daniel Kaulen, Boeblingen (DE); Johannes Greiner, Deckenpfronn (DE); Jonathan Allen Wildstrom, Austin, TX (US)

(21) Appl. No.: 18/674,676

(22) Filed: May 24, 2024

(51) Int. Cl. G06N 10/80; G06F 8/41; G06N 10/20; G06N 10/40

(52) U.S. Cl. CPC G06N 10/80; G06F 8/41; G06N 10/20; G06N 10/40

(57) ABSTRACT

A method, system, and computer program product for performing quantum circuit compilation independent of calibration. A calibration library is created with waveform or pulse generation instructions based on calibration data. A calibration library corresponds to pre-compiled code for the possible gates of the quantum circuit. Such pre-compiled code includes the waveform or pulse generation instructions. Furthermore, transpilation of a quantum circuit into a transpiled object is performed. After compiling the transpiled object into a binary, the calibration library is bound to the binary for execution on a quantum device. In this manner, by being able to compile the quantum circuit without knowing the exact calibration outcome, the requirement to re-compile the quantum circuit, such as when a calibration determines changing the waveform or pulse generation instructions between the compilation and execution of the quantum circuit, is precluded. As a result, there is increased efficiency of compute resources used for compilation.

### TECHNICAL FIELD

The present disclosure relates generally to quantum circuit compilation, and more particularly to quantum circuit compilation independent of calibration.

### BACKGROUND

Quantum circuits are run on quantum hardware by being transpiled and compiled into a binary or binaries (executable machine instructions) to be executed on the control electronics components of the quantum device. A quantum circuit is a model for quantum computation, similar to classical circuits, in which a computation is a sequence of quantum gates, measurements, initializations of qubits to known values, and possibly other actions.

Transpilation refers to the process of rewriting a given input quantum circuit to match the topology of a specific quantum device and/or to optimize the quantum circuit for execution on noisy quantum systems. That is, transpilation refers to the translation process of transforming a high-level quantum circuit into an equivalent circuit that is compatible with the specifications of a quantum device, including: basis gate set, topology of the quantum chip, timing constraints, fidelity of operations, etc.

Compiling involves translating the quantum program (list of instructions, such as quantum logic gates that must be applied to qubits in a certain order), which has been transpiled, into a binary (that can be executed on the control electronics).

Currently, at both transpile and compile time, the current calibration data is considered to optimally perform such processes (transpilation and compilation). For example, calibration data is utilized to determine which qubits are to be avoided during transpilation as well as used to generate the ideal waveform emissions for the gates in the binary. Calibration is a technique to compensate slight drifts in the hardware and to retain good quality of quantum circuit executions.

While the current calibration is utilized to perform transpilation and compilation, calibration data may change resulting in reperforming the compilation with the updated calibration data.

Such re-compiling impacts the jobs (units of work) that are being executed in the compilation flow. The compilation flow refers to the collection of jobs to be transpiled and compiled. For example, by having such reperformance, the execution of the jobs in the compilation flow may be delayed. Furthermore, additional compute resources are utilized to execute the jobs in the compilation flow.

Hence, as a result of changed calibrations, re-compiles are currently required resulting in the utilization of additional compute resources.

### SUMMARY

In one embodiment of the present disclosure, a method for performing quantum circuit compilation independent of calibration comprises creating a calibration library with waveform or pulse generation instructions based on calibration data. The method further comprises performing transpilation of a quantum circuit into a transpiled object. The method additionally comprises compiling the transpiled object into a binary. Furthermore, the method comprises binding the calibration library to the binary for execution on a quantum device.

Furthermore, in one embodiment of the present disclosure, the method additionally comprises receiving transpilation hints. The method further comprises performing the transpilation of the quantum circuit into the transpiled object using the transpilation hints.

Additionally, in one embodiment of the present disclosure, the method further comprises determining if the transpilation hints are valid.

Furthermore, in one embodiment of the present disclosure, the method additionally comprises updating the transpilation hints in response to the transpilation hints not being valid.

Additionally, in one embodiment of the present disclosure, the method further comprises executing the binary with the bound calibration library on the quantum device.

Furthermore, in one embodiment of the present disclosure, the method additionally comprises selecting a target partition. The method further comprises binding the calibration library to the binary for the target partition for execution on the quantum device.

Additionally, in one embodiment of the present disclosure, the method further comprises executing the binary with the bound calibration library for the target partition on the quantum device.

Other forms of the embodiments of the method described above are in a system and in a computer program product.

Accordingly, embodiments of the present disclosure enable quantum circuits to be compiled without knowing the exact calibration outcome thereby preventing the requirement to re-compile the quantum circuit, such as when a calibration determines changing the waveform or pulse generation instructions between the compilation and the execution of the quantum circuit. As a result, there is increased efficiency of compute resources used for compilation.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for performing quantum circuit compilation independent of calibration in accordance with an embodiment of the present disclosure;

FIG. 3 illustrates an embodiment of the present disclosure of the hardware configuration of the classical computer which is representative of a hardware environment for practicing the present disclosure;

FIG. 4 is a flowchart of a method for performing quantum circuit compilation independent of calibration in accordance with an embodiment of the present disclosure; and

FIG. 5 is a flowchart of a method for ensuring the validity of the transpilation hints in accordance with an embodiment of the present disclosure.

### DETAILED DESCRIPTION

In one embodiment of the present disclosure, a method for performing quantum circuit compilation independent of calibration comprises creating a calibration library with waveform or pulse generation instructions based on calibration data. The method further comprises performing transpilation of a quantum circuit into a transpiled object. The method additionally comprises compiling the transpiled object into a binary. Furthermore, the method comprises binding the calibration library to the binary for execution on a quantum device.

In this manner, quantum circuits can be compiled without knowing the exact calibration outcome thereby preventing the requirement to re-compile the quantum circuit, such as when a calibration determined changing the waveform or pulse generation instructions between the compilation and the execution of the quantum circuit. As a result, there is increased efficiency of compute resources used for compilation.

Furthermore, in one embodiment of the present disclosure, the method additionally comprises receiving transpilation hints. The method further comprises performing the transpilation of the quantum circuit into the transpiled object using the transpilation hints.

In this manner, the transpiler can receive hints of which qubits and two-qubit gates are to be avoided thereby leading to a superset of qubits and two-qubit gates that should be avoided during transpilation.

Additionally, in one embodiment of the present disclosure, the method further comprises determining if the transpilation hints are valid.

In this manner, the transpilation hints that are used by the transpiler to perform transpilation of the quantum circuit can be ensured to be valid.

Furthermore, in one embodiment of the present disclosure, the method additionally comprises updating the transpilation hints in response to the transpilation hints not being valid.

In this manner, the transpilation hints that are used by the transpiler to perform transpilation of the quantum circuit can be ensured to be valid.

Additionally, in one embodiment of the present disclosure, the method further comprises executing the binary with the bound calibration library on the quantum device.

In this manner, the compiled binary is bound to suitable calibration waveform instructions.

Furthermore, in one embodiment of the present disclosure, the method additionally comprises selecting a target partition. The method further comprises binding the calibration library to the binary for the target partition for execution on the quantum device.

In this manner, the compiled binary is bound to suitable calibration waveform instructions on the selected target partition.

Additionally, in one embodiment of the present disclosure, the method further comprises executing the binary with the bound calibration library for the target partition on the quantum device.

In this manner, the compiled binary is bound to suitable calibration waveform instructions on the selected target partition.

Other forms of the embodiments of the method described above are in a system and in a computer program product.

As stated above, transpilation refers to the process of rewriting a given input quantum circuit to match the topology of a specific quantum device and/or to optimize the quantum circuit for execution on noisy quantum systems. That is, transpilation refers to the translation process of transforming a high-level quantum circuit into an equivalent circuit that is compatible with the specifications of a quantum device, including: basis gate set, topology of the quantum chip, timing constraints, fidelity of operations, etc.

Compiling involves translating the quantum program (list of instructions, such as quantum logic gates that must be applied to qubits in a certain order), which has been transpiled, into a binary (that can be executed on the control electronics).

Currently, at both transpile and compile time, the current calibration data is considered to optimally perform such processes (transpilation and compilation). For example, calibration data is utilized to determine which qubits are to be avoided during transpilation as well as used to generate the ideal waveform emissions for the gates in the binary. Calibration is a technique to compensate slight drifts in the hardware and to retain good quality of quantum circuit executions.

While the current calibration is utilized to perform transpilation and compilation, calibration data may change resulting in reperforming the compilation with the updated calibration data.

Such re-compiling impacts the jobs (units of work) that are being executed in the compilation flow. The compilation flow refers to the collection of jobs to be transpiled and compiled. For example, by having such reperformance, the execution of the jobs in the compilation flow may be delayed. Furthermore, additional compute resources are utilized to execute the jobs in the compilation flow.

Hence, as a result of changed calibrations, re-compiles are currently required resulting in the utilization of additional compute resources.

The embodiments of the present disclosure provide the means for eliminating the requirement to re-compile due to change calibrations by binding or linking the compiled quantum circuit (i.e., the binary, which corresponds to the compiled object) to a calibration library (created with waveform or pulse generation instructions based on calibration data). A “calibration library,” as used herein, corresponds to pre-compiled code for the possible gates of the quantum circuit, which is dynamically linked to the compiled quantum circuit. As a result, quantum circuits can be compiled without knowing the exact calibration outcome thereby preventing the requirement to re-compile the quantum circuit, such as when a calibration determined changing the waveform or pulse generation instructions between the compilation and the execution of the quantum circuit. As a result, there is increased efficiency of compute resources used for compilation. These and other features will be discussed in further detail below.

In some embodiments of the present disclosure, the present disclosure comprises a method, system, and computer program product for performing quantum circuit compilation independent of calibration. In one embodiment of the present disclosure, a calibration library is created with waveform or pulse generation instructions based on calibration data. A calibration library, as used herein, corresponds to pre-compiled code for the possible gates of the quantum circuit. Such pre-compiled code includes waveform or pulse generation instructions. In one embodiment, such waveform or pulse generation instructions are formed by assessing calibration data and creating such waveform or pulse generation instructions. Calibration data, as used herein, refers to data generated during calibration. Calibration, as used herein, is a technique to reduce systematic errors in quantum circuits and determining the best waveform or pulse generation instructions needed to execute gate operations on a quantum device. Furthermore, transpilation of a quantum circuit into a transpiled object is performed. “Transpilation,” as used herein, is the process of rewriting a given input quantum circuit to match the topology of a specific quantum device and/or to optimize the quantum circuit for execution on present day noisy quantum systems. The resulting transpiled quantum circuit is referred to herein as the “transpiled object.” After compiling the transpiled object into a binary (object that can be sent to the quantum computer's hardware structure for execution), the binary is bound to the calibration library for execution on a quantum device. “Binding,” as used herein, refers to late binding, such as dynamically linking the calibration library to the binary thereby enabling the binary to be executed on the quantum device with the latest version of the calibration data. In one embodiment, the binding occurs by using a pre-defined code layout of waveform or pulse generation instructions so that execution of these instructions occurs by having the execution branch to these pre-defined code locations. In this manner, by being able to compile the quantum circuit without knowing the exact calibration outcome, the requirement to re-compile the quantum circuit, such as when a calibration determines changing the waveform or pulse generation instructions between the compilation and the execution of the quantum circuit, is precluded. As a result, there is increased efficiency of compute resources used for compilation.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

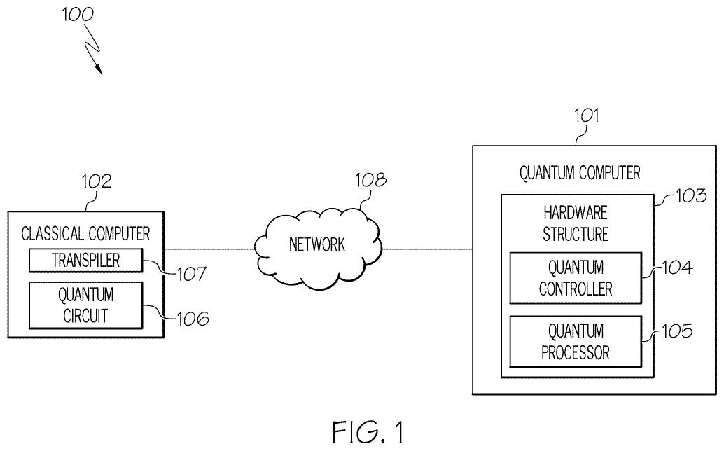

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 108 (discussed below).

In one embodiment, classical computer 102 is used to set up the state of quantum bits in quantum computer 101 and then quantum computer 101 starts the quantum process. Furthermore, in one embodiment, classical computer 102 is configured to perform quantum circuit compilation independent of calibration as discussed further below.

In one embodiment, a hardware structure 103 of quantum computer 101 includes a quantum controller 104 and a quantum processor 105. While depicted as being located on a single machine, quantum controller 104 may consist of internal components distributed across multiple systems, such as in a cloud computing architecture, or may be located in close proximity to quantum processor 105.

In one embodiment, quantum controller 104 performs the execution of the waveform or pulses to control the qubits in quantum processor 105. Quantum controller 104 can be implemented in hardware as integrated or discrete electronics components, or in software on a classical computer, or using a mixture of both hardware and software. In one embodiment, if quantum controller 104 is implemented in software or as a combination of software and specific hardware components, it can be co-located with other components of the present disclosure running in classical computer 102. In one embodiment, quantum controller 104 runs on a classical computer, including, but not limited to, classical computer 102.

In one embodiment, quantum processor 105 uses qubits to perform computational tasks. In the particular realms where quantum mechanics operate, particles of matter can exist in multiple states, such as an “on” state, an “off” state, and both “on” and “off” states simultaneously. Quantum processor 105 harnesses these quantum states of matter to output signals that are usable in data computing.

In one embodiment, quantum processor 105 performs algorithms which conventional processors are incapable of performing efficiently.

In one embodiment, classical computer 102 includes one or more quantum circuits 106. Quantum circuits 106 may collectively or individually be referred to as quantum circuits 106 or quantum circuit 106, respectively. A “quantum circuit 106,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (performs e^{iθX/2} which corresponds to a rotation of the qubit state around the X-axis by the given angle theta θ on the Bloch sphere), RY (performs e^{iθY/2}, which corresponds to a rotation of the qubit state around the Y-axis by the given angle theta θ on the Bloch sphere), RXX (performs the operation e^{(-iθX⊗X/2)} on the input qubit), RZZ (takes in one input, an angle theta θ expressed in radians, and it acts on two qubits), etc. In one embodiment, quantum circuits 106 are written such that the horizontal axis is time, starting at the left-hand side and ending at the right-hand side.

Furthermore, in one embodiment, quantum circuit 106 corresponds to a command structure provided to quantum controller 104 on how to operate quantum processor 105.

Furthermore, in one embodiment, classical computer 102 includes a “transpiler 107,” which as used herein, is configured to rewrite an abstract quantum circuit 106 into a functionally equivalent one that matches the constraints and characteristics of a specific target quantum device. In one embodiment, transpiler 107 (e.g., qiskit.transpiler, where Qiskit® is an open-source software development kit for working with quantum computers at the level of circuits, pulses, and algorithms) rewrites a given input quantum circuit to match the topology of a specific quantum device and/or to optimize the quantum circuit for execution. In one embodiment, transpiler 107 converts a trained machine learning model upon execution on quantum hardware 103 to its elementary instructions and maps it to physical qubits.

In one embodiment, quantum machine learning models are based on variational quantum circuits 106. Such models consist of data encoding, processing parameterized with trainable parameters, and measurement/post-processing.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to set up the state of quantum bits in quantum computer 101, may be connected to quantum computer 101 via network 108.

Network 108 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

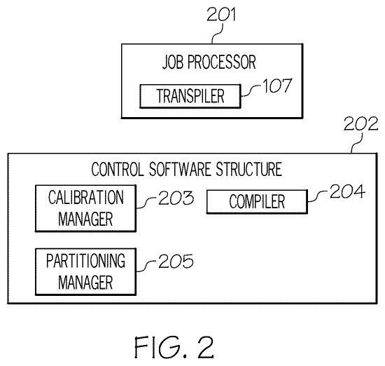

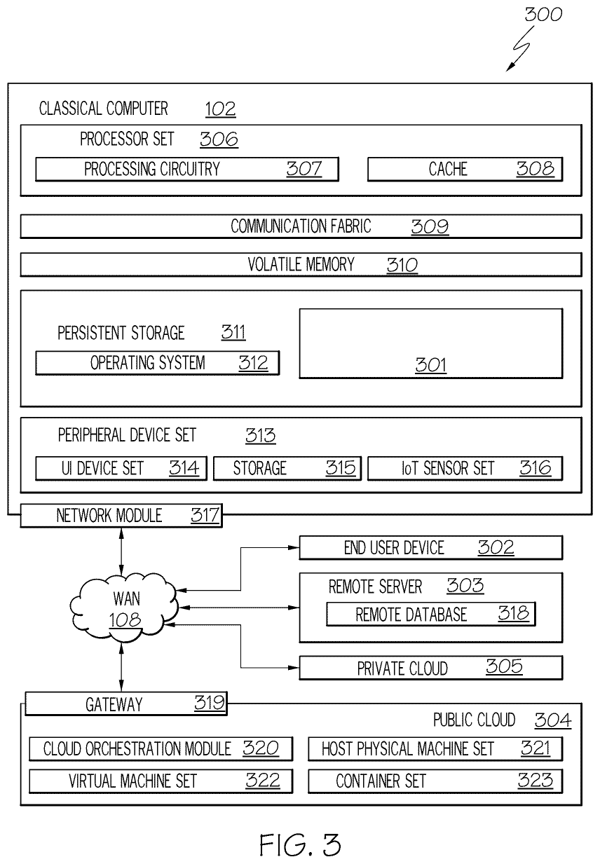

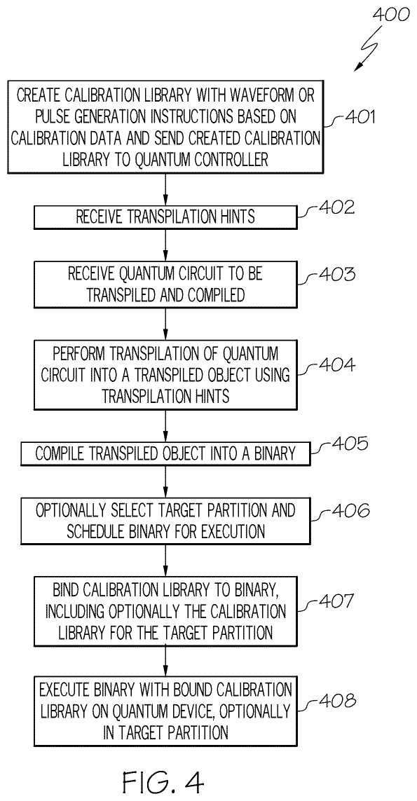

Furthermore, classical computer 102 is configured to perform quantum circuit compilation independent of calibration, such as in a control software structure, as discussed further below in connection with FIGS. 2 and 4. A description of the software components of classical computer 102 is provided below in connection with FIG. 2 and a description of the hardware configuration of classical computer 102 is provided further below in connection with FIG. 3.

System 100 is not to be limited in scope to any one particular network architecture. System 100 may include any number of quantum computers 101, classical computers 102, and networks 113. Furthermore, all listed components may be distributed across several instances of these entities.

A discussion regarding the software components used by classical computer 102 for performing quantum circuit compilation independent of calibration is provided below in connection with FIG. 2.

FIG. 2 is a diagram of the software components of classical computer 102 (FIG. 1) for performing quantum circuit compilation independent of calibration in accordance with an embodiment of the present disclosure.

Referring to FIG. 2, in conjunction with FIG. 1, classical computer 102 includes a job processor 201 configured to request execution of a job. As discussed above, the compilation flow refers to the collection of jobs of quantum circuits to be transpiled and compiled. A job, as used herein, refers to a unit of work, such as the transpilation and compilation of a quantum circuit, that is being executed in the compilation flow. In one embodiment, a job may correspond to quantum circuit 106.

In one embodiment, job processor 201 includes transpiler 107 that performs transpilation of a quantum circuit (e.g., quantum circuit 106) received by job processor 201. Transpilation, as used herein, refers to the process of rewriting a given input quantum circuit to match the topology of a specific quantum device and/or to optimize the quantum circuit for execution on noisy quantum systems. That is, transpilation refers to the compilation process of transforming a high-level quantum circuit into an equivalent circuit that is compatible with the specifications of a quantum device, including: basis gate set, topology of the quantum chip, timing constraints, fidelity of operations, etc.

In one embodiment, job processor 201 belongs to a service that receives a job and drives transpilation, compilation, and execution of the job.

In another embodiment, job processor 201 is owned by a user (e.g., user of classical computer 102). In such an embodiment, transpilation can be performed by that user as a manual step (following the procedure for transpilation described in the present disclosure) before it is submitted to a service that drives compilation and execution of the job.

Furthermore, in one embodiment, classical computer 102 includes a control software structure 202 that consists of several components utilized for the processing flow (also referred to herein as the compilation flow) of the present disclosure. While job processer 201 and control software structure 202 are depicted as being located on a single machine, these components can be distributed across multiple systems, such as in a cloud computing architecture, a microservice architecture, or can be located in close proximity, including being located on the same classical computer.

In one embodiment, control software structure 202 includes a calibration manager 203 configured to generate “transpilation hints” which are utilized by transpiler 107 to perform transpilation of the quantum circuit (e.g., quantum circuit 106) into a transpiled object. “Transpilation hints,” as used herein, refer to providing hardware state details, including on qubit quality (e.g., single or two-qubit gate quality), and/or other data determined during the calibration process (e.g., identifying which qubits and two-qubit gates are to be avoided and are not to be utilized for transpilation/compilation)

In one embodiment, calibration manager 203 provides transpilation hints for a multiplicity of potential partitions of quantum computer 101 thereby creating a multiplicity of transpilation hints. These transpilation hints contain the same nature of information as described above but are restricted to the scope of the corresponding partition.

In one embodiment, calibration manager 203 identifies the qubits and two-qubit gates to be avoided by identifying identical or largely overlapping topologies of static partitions of the quantum circuit, such as the same number of heavy hexagons spread over all the qubits, using the last calibration data used. Calibration data, as used herein, refers to data generated during calibration. Calibration, as used herein, is a technique to reduce systematic errors in quantum circuits and determining the best waveform or pulse generation instructions needed to execute gate operations on a quantum device. Static partitions, as used herein, refer to unchanging partitions of quantum computer 101. Dynamic partitions, as used herein, refer to partitions which are created only temporarily for execution of one or a few quantum circuits.

In one embodiment, transpiler 107 performs the transpilation of the quantum circuit (e.g., quantum circuit 106) into a transpiled object. As discussed above, transpilation is the process of rewriting a given input quantum circuit to match the topology of a specific quantum device and/or to optimize the quantum circuit for execution on present day noisy quantum systems. The resulting transpiled quantum circuit is referred to herein as the “transpiled object.”

In one embodiment, transpiler 107 uses the Qiskit® function, qiskit.transpiler, to perform the transpilation of the quantum circuit (e.g., quantum circuit 106) into a transpiled object using the transpilation hints.

As discussed above, in one embodiment, calibration manager 203 generates “transpilation hints” using the last calibration data used, which may later be updated. Using the last calibration data used is usually sufficient for performing transpilation since the qubit quality in relation to other qubits does not change fast. However, at times, the last calibration data used may have been updated significantly. In such a case, calibration manager 203 updates the transpilation hints using the updated calibration data, which are sent to transpiler 107. In one embodiment, such transpilation hints are updated by calibration manager 203 using the updated calibration data in the same manner as generating the transpilation hints discussed above.

In one embodiment, calibration manager 203 determines if the transpilation hints (currently active transpilation hints) need to be updated by determining if the generated transpilation hints are still valid. In one embodiment, the determination as to whether the generated transpilation hints are still valid is based on comparing the vectorized format of the last calibration data used and the updated calibration data. In one embodiment, calibration manager 203 vectorizes the last calibration data used and the updated calibration data, such as via Word2vec, Doc2Vec, GloVe, etc. After being converted into real-valued vectors, a similarity measure, such as cosine similarity or the Euclidean distance, may be used to determine the similarity between the content of the last calibration data used and the updated calibration data. Such a similarity measure is compared to a threshold value, which may be user-designated, to determine if the modification to the last calibration data used was significant enough to warrant updating the transpilation hints. If the similarity measure is less than a threshold value, then the transpilation hints are updated using the updated calibration data. Otherwise, the transpilation hints are still valid and are not updated.

“Cosine similarity,” as used herein, refers to a measure of similarity between two non-zero vectors defined in an inner product space. Cosine similarity is the cosine of the angle between the vectors. That is, it is the dot product of the vectors divided by the product of their lengths. If the measurement is less than threshold value, which may be user-designated, then the transpilation hints are updated using the updated calibration data. Otherwise, the transpilation hints are still valid and are not updated.

In one embodiment, the Euclidean distance is calculated as the square root of the sum of the squared differences between the two feature vectors. If the distance is less than a threshold value, which may be user-designated, then the transpilation hints are updated using the updated calibration data. Otherwise, the transpilation hints are still valid and are not updated.

In one embodiment, the similarity measure is a score between the values of 0 and 1 for vectors that have only positive values. In one embodiment, any negative scores can be made positive by taking its absolute value.

In another embodiment, the determination as to whether transpilation hints are valid is performed by transpiler 107 as opposed to calibration manager 203.

In one embodiment, calibration manager 203 creates a calibration library with the waveform or pulse generation instructions based on calibration data. A calibration library, as used herein, corresponds to pre-compiled code for the possible gates of the quantum circuit. Such pre-compiled code includes the waveform or pulse generation instructions. Calibration data, as used herein, refers to data generated during calibration. Calibration, as used herein, is a technique to reduce systematic errors in quantum circuits and determining the best waveform or pulse generation instructions needed to execute gate operations on a quantum device.

In one embodiment, such calibration data corresponds to a recent version of calibration data, which may have been recently updated. As discussed in further detail below, during the compilation process, such calibration input is utilized at the end of the process where the binary is bound to the calibration library (i.e., binary bound to the waveforms or pulses that are generated through calibration). In this manner, quantum circuits can be compiled without knowing the exact calibration outcome thereby preventing the requirement to re-compile the quantum circuit, such as when a calibration determines changing the waveform or pulse generation instructions between the compilation and the execution of the quantum circuit.

In one embodiment, control software structure 202 includes compiler 204 configured to compile the transpiled object (e.g., compile the transpiled object of quantum circuit 106 as transpiled by transpiler 107) into a binary for execution on quantum computer 101. “Compiling,” as used herein, refers to translating the quantum program (list of instructions, such as quantum logic gates that must be applied to qubits in a certain order), which has been transpiled, into a binary. A “binary,” as used herein, refers to an object that can be sent to the quantum computer's hardware structure (hardware structure 103 of FIG. 1) for execution. In one embodiment, compiler 204 compiles the transpiled object into a binary using the Qiskit® function, qiskit.compiler.

Returning to FIG. 1, in conjunction with FIG. 2, as discussed above, hardware structure 103 includes quantum controller 104, which is configured to bind the calibration library to the binary for execution on a quantum device (e.g., quantum computer 101). “Binding,” as used herein, refers to late binding, such as dynamically linking the calibration library to the binary thereby enabling the binary to be executed on the quantum device with the latest version of the calibration data. By being able to compile the quantum circuit without knowing the exact calibration outcome, the requirement to re-compile the quantum circuit, such as when a calibration determines changing the waveform or pulse generation instructions between the compilation and the execution of the quantum circuit, is precluded. As a result, there is increased efficiency of compute resources used for compilation.

In one embodiment, quantum controller 104 binds the calibration library to the binary by loading the binary into memory of quantum controller 104 and utilizing a table (e.g., jump table) which includes the calibration library to be dynamically linked to the binary. In one embodiment, such a table includes an identifier associated with the stored calibration library that indicates the transpiled quantum circuit upon which the calibration library was created. In one embodiment, the transpiled quantum circuit that is compiled into a binary is identified by quantum controller 104. In one embodiment, such an identifier of the transpiled quantum circuit is matched with an identifier stored in the table, which identifies the appropriate calibration library which is to be dynamically linked or bound to the binary.

In one embodiment, quantum controller 104 is configured to execute the binary bound to the calibration library on the quantum device, where the instructions in the bound calibration library are used to execute the waveform or pulse generation instructions.

Returning to FIG. 2, in one embodiment, classical computer 102 may optionally include partitioning manager 205 configured to select a target partition of the quantum computer and schedule the binary for execution for the target partition. A “target partition,” as used herein, refers to a separate area of the quantum computer (e.g., quantum computer 101), such as separate qubits, for the binary to be executed. In one embodiment, transpilation hints are to be utilized for transpilation/compilation from the target partition.

Referring to FIG. 1, in conjunction with FIG. 2, in one embodiment, quantum controller 104 is configured to bind the calibration library to the binary for the target partition for execution on a quantum device (e.g., quantum computer 101). Quantum controller 104 then executes the binary with the bound calibration library for the target partition on the quantum device. In one embodiment, only the appropriate portion of the calibration library is bound to the binary based on the target partition.

As a result, quantum circuits can be compiled without knowing the exact calibration outcome thereby preventing the requirement to re-compile the quantum circuit, such as when a calibration determines changing the waveform or pulse generation instructions between the compilation and the execution of the quantum circuit. That is, calibrations can change without the user program and binary changing. Consequently, there is faster circuit compilation in the compilation flow leading to improved performance. As a result, there is increased efficiency of compute resources used for compilation.

A further description of these and other functions is provided below in connection with the discussion of the method for performing quantum circuit compilation independent of calibration.

Prior to the discussion of the method for performing quantum circuit compilation independent of calibration, a description of the hardware configuration of classical computer 102 (FIG. 1) is provided below in connection with FIG. 3.

Referring now to FIG. 3, in conjunction with FIG. 1, FIG. 3 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code 301 involved in performing the inventive methods, such as performing quantum circuit compilation independent of calibration. In addition to block 301, computing environment 300 includes, for example, classical computer 102, network 108, such as a wide area network (WAN), end user device (EUD) 302, remote server 303, public cloud 304, and private cloud 305. In this embodiment, classical computer 102 includes processor set 306 (including processing circuitry 307 and cache 308), communication fabric 309, volatile memory 310, persistent storage 311 (including operating system 312 and block 301, as identified above), peripheral device set 313 (including user interface (UI) device set 314, storage 315, and Internet of Things (IoT) sensor set 316), and network module 317. Remote server 303 includes remote database 318. Public cloud 304 includes gateway 319, cloud orchestration module 320, host physical machine set 321, virtual machine set 322, and container set 323.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 318. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically classical computer 102, to keep the presentation as simple as possible. Classical computer 102 may be located in a cloud, even though it is not shown in a cloud in FIG. 3. On the other hand, classical computer 102 is not required to be in a cloud except to any extent as may be affirmatively indicated.

Processor set 306 includes one, or more, computer processors of any type now known or to be developed in the future. Processing circuitry 307 may be distributed over multiple packages, for example, multiple, coordinated integrated circuit chips. Processing circuitry 307 may implement multiple processor threads and/or multiple processor cores. Cache 308 is memory that is located in the processor chip package(s) and is typically used for data or code that should be available for rapid access by the threads or cores running on processor set 306. Cache memories are typically organized into multiple levels depending upon relative proximity to the processing circuitry. Alternatively, some, or all, of the cache for the processor set may be located “off chip.” In some computing environments, processor set 306 may be designed for working with qubits and performing quantum computing.

Computer readable program instructions are typically loaded onto classical computer 102 to cause a series of operational steps to be performed by processor set 306 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 308 and the other storage media discussed below. The program instructions, and associated data, are accessed by processor set 306 to control and direct performance of the inventive methods. In computing environment 300, at least some of the instructions for performing the inventive methods may be stored in block 301 in persistent storage 311.

Communication fabric 309 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 310 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 310 is located in a single package and is internal to classical computer 102, but, alternatively or additionally, the volatile memory may be distributed over multiple packages and/or located externally with respect to classical computer 102.

Persistent Storage 311 is any form of non-volatile storage for computers that is now known or to be developed in the future. The non-volatility of this storage means that the stored data is maintained regardless of whether power is being supplied to classical computer 102 and/or directly to persistent storage 311. Persistent storage 311 may be a read only memory (ROM), but typically at least a portion of the persistent storage allows writing of data, deletion of data and re-writing of data. Some familiar forms of persistent storage include magnetic disks and solid state storage devices. Operating system 312 may take several forms, such as various known proprietary operating systems or open source Portable Operating System Interface type operating systems that employ a kernel. The code included in block 301 typically includes at least some of the computer code involved in performing the inventive methods.

Peripheral device set 313 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 314 may include components such as a display screen, speaker, microphone, wearable devices (such as goggles and smart watches), keyboard, mouse, printer, touchpad, game controllers, and haptic devices. Storage 315 is external storage, such as an external hard drive, or insertable storage, such as an SD card. Storage 315 may be persistent and/or volatile. In some embodiments, storage 315 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 316 is made up of sensors that can be used in Internet of Things applications. For example, one sensor may be a thermometer and another sensor may be a motion detector.

Network module 317 is the collection of computer software, hardware, and firmware that allows classical computer 102 to communicate with other computers through WAN 108. Network module 317 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 317 are performed on the same physical hardware device. In other embodiments (for example, embodiments that utilize software-defined networking (SDN)), the control functions and the forwarding functions of network module 317 are performed on physically separate devices, such that the control functions manage several different network hardware devices. Computer readable program instructions for performing the inventive methods can typically be downloaded to classical computer 102 from an external computer or external storage device through a network adapter card or network interface included in network module 317.

WAN 108 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 302 is any computer system that is used and controlled by an end user (for example, a customer of an enterprise that operates classical computer 102), and may take any of the forms discussed above in connection with classical computer 102. EUD 302 typically receives helpful and useful data from the operations of classical computer 102. For example, in a hypothetical case where classical computer 102 is designed to provide a recommendation to an end user, this recommendation would typically be communicated from network module 317 of classical computer 102 through WAN 108 to EUD 302. In this way, EUD 302 can display, or otherwise present, the recommendation to an end user. In some embodiments, EUD 302 may be a client device, such as thin client, heavy client, mainframe computer, desktop computer and so on.

Remote server 303 is any computer system that serves at least some data and/or functionality to classical computer 102. Remote server 303 may be controlled and used by the same entity that operates classical computer 102. Remote server 303 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 318 of remote server 303.

Public cloud 304 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 304 is performed by the computer hardware and/or software of cloud orchestration module 320. The computing resources provided by public cloud 304 are typically implemented by virtual computing environments that run on various computers making up the computers of host physical machine set 321, which is the universe of physical computers in and/or available to public cloud 304. The virtual computing environments (VCEs) typically take the form of virtual machines from virtual machine set 322 and/or containers from container set 323. It is understood that these VCEs may be stored as images and may be transferred among and between the various physical machine hosts, either as images or after instantiation of the VCE. Cloud orchestration module 320 manages the transfer and storage of images, deploys new instantiations of VCEs and manages active instantiations of VCE deployments. Gateway 319 is the collection of computer software, hardware, and firmware that allows public cloud 304 to communicate through WAN 108.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 305 is similar to public cloud 304, except that the computing resources are only available for use by a single enterprise. While private cloud 305 is depicted as being in communication with WAN 108 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 304 and private cloud 305 are both part of a larger hybrid cloud.

Block 301 further includes the software components discussed above in connection with FIG. 2 to perform quantum circuit compilation independent of calibration. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for performing quantum circuit compilation independent of calibration, may be embodied in an application specific integrated circuit.

As stated above, currently, at both transpile and compile time, the current calibration data is considered to optimally perform such processes (transpilation and compilation). For example, calibration data is utilized to determine which qubits are to be avoided during transpilation as well as used to generate the ideal waveform emissions for the gates in the binary. Calibration is a technique to compensate slight drifts in the hardware and to retain good quality of quantum circuit executions. While the current calibration is utilized to perform transpilation and compilation, calibration data may change resulting in reperforming the compilation with the updated calibration data. Such re-compiling impacts the jobs (units of work) that are being executed in the compilation flow. The compilation flow refers to the collection of jobs to be transpiled and compiled. For example, by having such reperformance, the execution of the jobs in the compilation flow may be delayed. Furthermore, additional compute resources are utilized to execute the jobs in the compilation flow. Hence, as a result of changed calibrations, re-compiles are currently required resulting in the utilization of additional compute resources.

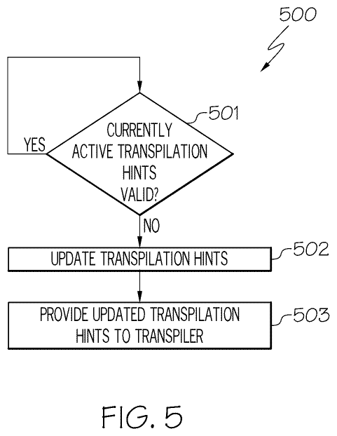

The embodiments of the present disclosure provide the means for eliminating the requirement to re-compile due to change calibrations by binding or linking a calibration library (created with pulse generation instructions based on calibration data) with the compiled quantum circuit (i.e., the binary, which corresponds to the compiled transpiled object) as discussed below in connection with FIGS. 4 and 5. FIG. 4 is a flowchart of a method for performing quantum circuit compilation independent of calibration. FIG. 5 is a flowchart of a method for ensuring the validity of the transpilation hints.

As stated above, FIG. 4 is a flowchart of a method 400 for performing quantum circuit compilation independent of calibration in accordance with an embodiment of the present disclosure.

Referring to FIG. 4, in conjunction with FIGS. 1-3, in step 401, calibration manager 203 of control software structure 202 creates a calibration library with the waveform or pulse generation instructions based on calibration data and sends the calibration library to quantum controller 104.

In one embodiment, the calibration libraries are sent to quantum controller 104 by calibration manager 203 whenever calibration manager 203 notices any change needed in necessary waveform or pulse generation instructions as detected by the calibration routine.

As discussed above, a calibration library, as used herein, corresponds to pre-compiled code for the possible gates of the quantum circuit. Such pre-compiled code includes the waveform or pulse generation instructions. Calibration data, as used herein, refers to data generated during calibration. Calibration, as used herein, is a technique to reduce systematic errors in quantum circuits and determining the best waveform or pulse generation instructions needed to execute gate operations on a quantum device.

In one embodiment, such calibration data corresponds to a recent version of calibration data, which may have been recently updated. As discussed in further detail below, during the compilation process, such calibration input is utilized at the end of the process where the calibration library is bound to the binary (i.e., binary bound to the waveforms that are generated through calibration). In this manner, quantum circuits can be compiled without knowing the exact calibration outcome thereby preventing the requirement to re-compile the quantum circuit, such as when a calibration determines changing the waveform or pulse generation instructions between the compilation and the execution of the quantum circuit.

In one embodiment, job processor 201 includes transpiler 107 that performs transpilation of a quantum circuit received by job processor 201, where optionally such a quantum circuit 106 is identified from the next job in the compilation flow to be processed by job processor 201. Transpilation, as used herein, refers to the process of rewriting a given input quantum circuit to match the topology of a specific quantum device and/or to optimize the quantum circuit for execution on noisy quantum systems. That is, transpilation refers to the compilation process of transforming a high-level quantum circuit into an equivalent circuit that is compatible with the specifications of a quantum device, including: basis gate set, topology of the quantum chip, timing constraints, fidelity of operations, etc.

In step 402, job processor 201 of classical computer 102 receives transpilation hints that were generated by calibration manger 203.

As stated above, calibration manager 203 generates “transpilation hints” which are utilized by transpiler 107 of job processor 201 to perform transpilation of the quantum circuit (e.g., quantum circuit 106) into a transpiled object. “Transpilation hints,” as used herein, refer to providing hardware state details, including on qubit quality (e.g., single or two-qubit gate quality), and/or other data determined during the calibration process (e.g., identifying which qubits and two-qubit gates are to be avoided and are not to be utilized for transpilation/compilation).

In step 403, job processor 201 of classical computer 102 receives a quantum circuit (e.g., quantum circuit 106) to be transpiled and compiled.

As discussed above, in one embodiment, job processor 201 triggers the processing flow for a job. The processing flow (also referred to herein as the compilation flow) refers to one or a collection of jobs of quantum circuits to be transpiled, compiled, and executed. A job, as used herein, refers to a unit of work, such as the transpilation and compilation of a quantum circuit, that is being executed in the processing flow.

In step 404, transpiler 107 of job processor 201 performs the transpilation of the quantum circuit into a transpiled object using the transpilation hints. As discussed above, transpilation is the process of rewriting a given input quantum circuit to match the topology of a specific quantum device and/or to optimize the quantum circuit for execution on present day noisy quantum systems. The resulting transpiled quantum circuit is referred to herein as the “transpiled object.”

In one embodiment, transpiler 107 uses the Qiskit® function, qiskit.transpiler, to perform the transpilation of the quantum circuit into a transpiled object using the transpilation hints.

In step 405, compiler 204 of control software structure 202 compiles the transpiled object into a binary.

As stated above, “compiling,” as used herein, refers to translating the transpiled object into a binary. A “binary,” as used herein, refers to an object that can be sent to the quantum computer's hardware structure (hardware structure 103) for execution. For example, a binary refers to a suitable format to execute on quantum controller 104.

In one embodiment, compiler 204 compiles the transpiled object into a binary using the Qiskit® function, qiskit.compiler.

In step 406, partitioning manager 205 of control software structure 202 optionally selects a target partition of the quantum computer and schedules the binary for execution for the target partition. A “target partition,” as used herein, refers to a separate area of the quantum computer, such as separate qubits, for the binary to be executed.

As discussed above, transpilation hints are used identify which qubits and operations, such as two-qubit gates, are to be avoided thereby leading to improved quality of quantum circuit execution. In one embodiment, those hints of qubits and two-qubit gate avoidance are utilized for transpilation and/or compilation for the target partition.

In step 407, quantum controller 104 binds the calibration library, optionally the calibration library for the target partition, to the binary for execution on a quantum device (e.g., quantum computer 101).

As stated above, “binding,” as used herein, refers to late binding, such as dynamically linking the calibration library to the binary, and optionally for the target partition, thereby enabling the binary to be executed on the quantum device with the latest version of the calibration data. By being able to compile the quantum circuit without knowing the exact calibration outcome, the requirement to re-compile the quantum circuit, such as when a calibration determines changing the waveform or pulse generation instructions between the compilation and the execution of the quantum circuit, is precluded. As a result, there is increased efficiency of compute resources used for compilation.

In one embodiment, quantum controller 104 binds the calibration library to the binary by loading the binary into memory and utilizing a table (e.g., jump table) stored in a storage device of classical computer 102 or hardware structure 103 which includes the calibration library to be dynamically linked to the binary. In one embodiment, such a table includes an identifier associated with the stored calibration library that indicates the transpiled quantum circuit upon which the calibration library was created. In one embodiment, the transpiled quantum circuit that is compiled into a binary is identified by quantum controller 104. In one embodiment, such an identifier of the transpiled quantum circuit is matched with an identifier stored in the table, which identifies the appropriate calibration library which is to be dynamically linked or bound to the binary.

In another embodiment, quantum controller 104 binds the calibration library to the binary by dynamically linking a static or dynamic shared object file to the compile output.

In step 408, quantum controller 104 executes the binary with the bound calibration library on the quantum device, optionally in the target partition, where the bound calibration library is used for identifying the waveform or pulse generation instructions to be executed.

In one embodiment, concerning the embodiment for executing the binary with the bound calibration library for the target partition on the quantum device, only the appropriate portion of the calibration library is bound to the binary based on the target partition.

As a result, quantum circuits can be compiled without knowing the exact calibration outcome thereby preventing the requirement to re-compile the quantum circuit, such as when a calibration determines changing the waveform or pulse generation instructions between the compilation and the execution of the quantum circuit. That is, calibrations can change without the user program and binary changing. Consequently, there is faster circuit compilation in the compilation flow leading to improved performance. As a result, there is increased efficiency of compute resources used for compilation.

As discussed above, using the last calibration data used is usually sufficient for performing transpilation since the qubit quality in relation to other qubits does not change fast. However, at times, the last calibration data used may have been updated significantly. In such a case, the transpilation hints need to be updated as discussed below in connection with FIG. 5.

FIG. 5 is a flowchart of a method 500 for ensuring the validity of the transpilation hints in accordance with an embodiment of the present disclosure.

Referring to FIG. 5, in conjunction with FIGS. 1-4, in step 501, calibration manager 203 of control software structure 202 determines if the currently active transpilation hints are still valid. That is, calibration manager 203 determines if the values of the currently active transpilation hints are sufficiently in close range to the previously used transpilation hints. In another embodiment, such a determination is performed by transpiler 107.

As stated above, calibration manager 203 determines if the transpilation hints need to be updated by determining if the generated transpilation hints are still valid. In one embodiment, the determination as to whether the generated transpilation hints are still valid is based on comparing the vectorized format of the last calibration data used and the updated calibration data. In one embodiment, calibration manager 203 vectorizes the last calibration data used and the updated calibration data, such as via Word2vec, Doc2Vec, GloVe, etc. After being converted into real-valued vectors, a similarity measure, such as cosine similarity or the Euclidean distance, may be used to determine the similarity between the content of the last calibration data used and the updated calibration data. Such a similarity measure is compared to a threshold value, which may be user-designated, to determine if the modification to the last calibration data used was significant enough to warrant updating the transpilation hints. If the similarity measure is less than such a threshold value, then the transpilation hints are updated using the updated calibration data. Otherwise, the transpilation hints are still valid and are not updated.

In another embodiment, such a threshold value is determined based on heuristics.

In both cases, i.e., regardless whether the similarity measure is less than a threshold value or not, the updated calibration data can trigger the generation of one (or several, in the case of partitions) calibration libraries by calibration manager 203. In one embodiment, such generated calibration libraries are passed to quantum controller 104 as discussed above in connection with step 401.

As discussed above, a similarity measure, such as cosine similarity or the Euclidean distance, may be used to determine the similarity between the content of the last calibration data used and the updated calibration data.

“Cosine similarity,” as used herein, refers to a measure of similarity between two non-zero vectors defined in an inner product space. Cosine similarity is the cosine of the angle between the vectors. That is, it is the dot product of the vectors divided by the product of their lengths. If the measurement is less than a threshold value, which may be user-designated, then the transpilation hints are updated using the updated calibration data. Otherwise, the transpilation hints are still valid and are not updated.

In one embodiment, the Euclidean distance is calculated as the square root of the sum of the squared differences between the two feature vectors. If the distance is less than a threshold value, which may be user-designated, then the transpilation hints are updated using the updated calibration data. Otherwise, the transpilation hints are still valid and are not updated.

In one embodiment, the similarity measure is a score between the values of 0 and 1 for vectors that have only positive values. In one embodiment, any negative scores can be made positive by taking its absolute value.

Referring again to step 501, if the currently active transpilation hints are still valid, then calibration manager 203 of control software structure 202 continues to determine if the currently active transpilation hints are valid in step 501.

If, however, the currently active transpilation hints are not valid, then, in step 502, calibration manager 203 of control software structure 202 updates the transpilation hints using the updated calibration data. In one embodiment, such transpilation hints are updated by calibration manager 203 using the updated calibration data in the same manner as generating the transpilation hints discussed above.

In step 503, calibration manager 203 of control software structure 202 provides the updated transpilation hints to transpiler 107.

As a result of the foregoing, the quantum circuit can be compiled without knowing the exact calibration outcome. Consequently, the requirement to re-compile the quantum circuit, such as when a calibration determines changing the waveform or pulse generation instructions between the compilation and the execution of the quantum circuit, is precluded. As a result, there is increased efficiency of compute resources used for compilation.

Furthermore, the principles of the present disclosure improve the technology or technical field involving quantum circuit compilation.

As discussed above, currently, at both transpile and compile time, the current calibration data is considered to optimally perform such processes (transpilation and compilation). For example, calibration data is utilized to determine which qubits are to be avoided during transpilation as well as used to generate the ideal waveform emissions for the gates in the binary. Calibration is a technique to compensate slight drifts in the hardware and to retain good quality of quantum circuit executions. While the current calibration is utilized to perform transpilation and compilation, calibration data may change resulting in reperforming the compilation with the updated calibration data. Such re-compiling impacts the jobs (units of work) that are being executed in the compilation flow. The compilation flow refers to the collection of jobs to be transpiled and compiled. For example, by having such reperformance, the execution of the jobs in the compilation flow may be delayed. Furthermore, additional compute resources are utilized to execute the jobs in the compilation flow. Hence, as a result of changed calibrations, re-compiles are currently required resulting in the utilization of additional compute resources.

Embodiments of the present disclosure improve such technology by creating a calibration library with waveform or pulse generation instructions based on calibration data. A calibration library, as used herein, corresponds to pre-compiled code for the possible gates of the quantum circuit. Such pre-compiled code includes waveform or pulse generation instructions. In one embodiment, such waveform or pulse generation instructions are formed by assessing calibration data and creating such waveform or pulse generation instructions. Calibration data, as used herein, refers to data generated during calibration. Calibration, as used herein, is a technique to reduce systematic errors in quantum circuits and determining the best waveform or pulse generation instructions needed to execute gate operations on a quantum device. Furthermore, transpilation of a quantum circuit into a transpiled object is performed. “Transpilation,” as used herein, is the process of rewriting a given input quantum circuit to match the topology of a specific quantum device and/or to optimize the quantum circuit for execution on present day noisy quantum systems. The resulting transpiled quantum circuit is referred to herein as the “transpiled object.” After compiling the transpiled object into a binary (object that can be sent to the quantum computer's hardware structure for execution), the binary is bound to the calibration library for execution on a quantum device. “Binding,” as used herein, refers to late binding, such as dynamically linking the calibration library to the binary thereby enabling the binary to be executed on the quantum device with the latest version of the calibration data. In one embodiment, the binding occurs by using a pre-defined code layout of waveform or pulse generation instructions so that execution of these instructions occurs by having the execution branch to these pre-defined code locations. In this manner, by being able to compile the quantum circuit without knowing the exact calibration outcome, the requirement to re-compile the quantum circuit, such as when a calibration determines changing the waveform or pulse generation instructions between the compilation and the execution of the quantum circuit, is precluded. As a result, there is increased efficiency of compute resources used for compilation. Furthermore, in this manner, there is an improvement in the technical field involving quantum circuit compilation.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for performing quantum circuit compilation independent of calibration, the method comprising:
creating a calibration library with waveform or pulse generation instructions based on calibration data;
performing transpilation of a quantum circuit into a transpiled object;
compiling said transpiled object into a binary; and
binding said calibration library to said binary for execution on a quantum device.

2. The method as recited in claim 1 further comprising:
receiving transpilation hints; and
performing said transpilation of said quantum circuit into said transpiled object using said transpilation hints.

3. The method as recited in claim 2 further comprising:
determining if said transpilation hints are valid.

4. The method as recited in claim 3 further comprising:
updating said transpilation hints in response to said transpilation hints not being valid.

5. The method as recited in claim 1 further comprising:
executing said binary with said bound calibration library on said quantum device.

6. The method as recited in claim 1 further comprising:
selecting a target partition; and
binding said calibration library to said binary for said target partition for execution on said quantum device.

7. The method as recited in claim 6 further comprising:
executing said binary with said bound calibration library for said target partition on said quantum device.

8. A computer program product for performing quantum circuit compilation independent of calibration, the computer program product comprising one or more computer readable storage mediums having program code embodied therewith, the program code comprising programming instructions for:
creating a calibration library with waveform or pulse generation instructions based on calibration data;
performing transpilation of a quantum circuit into a transpiled object;
compiling said transpiled object into a binary; and
binding said calibration library to said binary for execution on a quantum device.

9. The computer program product as recited in claim 8, wherein the program code further comprises the programming instructions for:
receiving transpilation hints; and
performing said transpilation of said quantum circuit into said transpiled object using said transpilation hints.

10. The computer program product as recited in claim 9, wherein the program code further comprises the programming instructions for:
determining if said transpilation hints are valid.

11. The computer program product as recited in claim 10, wherein the program code further comprises the programming instructions for:
updating said transpilation hints in response to said transpilation hints not being valid.

12. The computer program product as recited in claim 8, wherein the program code further comprises the programming instructions for:
executing said binary with said bound calibration library on said quantum device.

13. The computer program product as recited in claim 8, wherein the program code further comprises the programming instructions for:
selecting a target partition; and
binding said calibration library to said binary for said target partition for execution on said quantum device.

14. The computer program product as recited in claim 13, wherein the program code further comprises the programming instructions for:
executing said binary with said bound calibration library for said target partition on said quantum device.

15. A system, comprising:
a memory for storing a computer program for performing quantum circuit compilation independent of calibration; and
a processor connected to said memory, wherein said processor is configured to execute program instructions of the computer program comprising:
creating a calibration library with waveform or pulse generation instructions based on calibration data;
performing transpilation of a quantum circuit into a transpiled object;
compiling said transpiled object into a binary; and
binding said calibration library to said binary for execution on a quantum device.

16. The system as recited in claim 15, wherein the program instructions of the computer program further comprise:
receiving transpilation hints; and
performing said transpilation of said quantum circuit into said transpiled object using said transpilation hints.

17. The system as recited in claim 16, wherein the program instructions of the computer program further comprise:
determining if said transpilation hints are valid.

18. The system as recited in claim 17, wherein the program instructions of the computer program further comprise:
updating said transpilation hints in response to said transpilation hints not being valid.

19. The system as recited in claim 15, wherein the program instructions of the computer program further comprise:
executing said binary with said bound calibration library on said quantum device.

20. The system as recited in claim 15, wherein the program instructions of the computer program further comprise:
selecting a target partition; and
binding said calibration library to said binary for said target partition for execution on said quantum device.
